(19) United States
(12) Patent Application Publication
(10) Pub. No.: US 2005/0048240 A1
(43) Pub. Date: Mar. 3, 2005

(54) Tubular member made of fluororesin

(76) Inventors: Yukihiko Hayashi, Mito-shi (JP); Masahiro Suzuki, Tokorozawa-shi (JP)

Correspondence Address: W. L. Gore & Associates, Inc., 551 Paper Mill Road, P.O. Box 9206, Newark, DE, 19714-9206, US

(21) Appl. No.: 10/918,765

(22) Filed: Aug. 13, 2004

(30) Foreign Application Priority Data
Aug. 26, 2003 (JP) 2003-301450

(51) Int. Cl. B32B 1/08

(52) U.S. Cl. 428/36.92

(57) ABSTRACT

The invention relates to a fluororesin tube. More specifically, the invention provides a fluororesin tubular member that has low gas permeability. The fluororesin tubular member of the present invention uses a fluororesin as a starting material and is stretched in the axial direction and heat set once molding has been performed. Gas permeability may accordingly be reduced as compared to tubular bodies obtained merely by means of the molding of a fluororesin; therefore, if the tubular member is used as a material for chemical supply lines or other pipework that requires a fluororesin tube, it is possible to prevent gas from leaking and condensation from forming on the piping surface.

### FIELD OF THE INVENTION

The present invention relates to a fluororesin tubular member, and, when used as a hose, tube, or other means to convey fluids or the like, relates to a fluororesin tubular member having exceptional gas-barrier properties with minimal gas permeability.

### BACKGROUND OF THE INVENTION

Materials made of fluororesins are extensively used in applications ranging from semiconductor manufacturing processes to those wherein chemical resistance is required. For example, hoses, tubes, and other tubular members manufactured from fluororesin materials by means of extrusion molding are employed in pipework used for fluids.

However, tubular members made of fluororesins have the characteristic of being highly gas-permeable, so that films and tubes made from tetrafluoroethylene-fluoroalkyl vinyl ether copolymer (PFA), tetrafluoroethylene-hexafluoropropylene copolymer (FEP), and polytetrafluoroethylene (PTFE), which are extensively used fluororesins, may be employed as gas-permeable membranes used in sensors for detecting oxygen and other gases in water; and the tubes may be used for such purposes as removing dissolved gases contained in fluids used in semiconductor manufacturing processes.

On the other hand, problems are encountered when hoses, tubes, or the like made from fluororesins are used to convey pure water or other fluids in applications ranging from semiconductor manufacturing processes to those wherein chemical resistance is demanded; i.e., when gases dissolved in fluids, or vapors from these fluids leak from such tubes or the like, and these leaked gases may condense on the surfaces of the tubes or the like, causing the area surrounding the tube to get wet from the liquid.

It accordingly becomes necessary to wipe the liquids from the piping surfaces, replace the tubes, or perform other such activities on a frequent basis in semiconductor manufacturing processes.

In order to prevent or inhibit gas from permeating members made from synthetic resins, methods are performed that typically involve fashioning multilayered tubes using members that exhibit low gas permeability; vapor-depositing a metal, ceramic, or other material; plating a metal; or admixing a filler therewith.

However, tubes made of fluororesins are employed in applications requiring chemical resistance, or requiring the pollution caused as a result of substances eluting from the tube to be prevented, which renders impossible the use of countermeasures such as establishing a multilayered structure or adding other substances to the fluororesin composition in order to lower the gas permeability.

### SUMMARY

It is an object of the present invention to use a hose, tube, or other fluororesin tubular member to prevent gases from leaking, and the leaked vapor from condensing on the tube surface, by means of reducing the gas permeability without compromising the chemical resistance and other exceptional characteristics inherent in the fluororesin.

The problems of the present invention are resolved with a fluororesin tubular member obtained by means of heat-setting a tubular body formed from a fluororesin following stretching in the axial direction.

The fluororesin tubular member is annealed and heat-set at a temperature that is at or below the molding temperature after being stretched in a heated state at a temperature that is at or below the molding temperature.

The fluororesin tubular member is stretched to a length that is two to ten times as great as its pre-stretched length.

The fluororesin in the fluororesin tubular member is at least one compound selected from among polytetrafluoroethylene (PTFE), tetrafluoroethylene-hexafluoropropylene copolymer (FEP), tetrafluoroethylene-fluoroalkyl vinyl ether copolymer (PFA), ethylene-tetrafluoroethylene copolymer (ETFE), polyvinylidene fluoride (PVDF), polychlorofluoroethylene (PCTFE), and tetrafluoroethylene-hexafluoropropylene-vinylidene fluoride ternary copolymer (THV).

The fluororesin in the fluororesin tubular member comprises a thermoplastic resin, and is formed after having been melted.

The fluororesin tubular member of the present invention is stretched and heat set after molding, making it possible to obtain a product in which the gas permeability is reduced and the chemical resistance or other characteristics remain unaffected in comparison with those of the pre-stretched fluororesin tubular member. It is accordingly possible to provide a fluororesin tube in which gas leakage and condensation on the tube surface is reduced when the tube is used for supplying chemicals in semiconductor manufacturing processes or the like.

### BRIEF DESCRIPTION OF THE DRAWINGS

FIG. 1 is a diagram used to illustrate the method for evaluating the gas permeability of the sample and comparative tubes of the present invention.

### DESCRIPTION OF THE INVENTION

In the present invention, it was discovered that stretching the fluororesin tube in the axial direction after molding enables the gas permeability to be reduced without the composition or other attributes of the fluororesin tube being altered.

It is unclear as to why the gas permeability of the fluororesin tube of the present invention is lower than that of the unstretched tube, but it is presumed that the molecules of the fluororesin become oriented in the axial direction and arranged tightly along the tube wall as a result of stretching being performed after molding.

The fluororesin that can be used in tubes made from the fluororesin in the present invention may be used in a wide variety of applications, provided that the fluororesin material may be molded into a tubular shape by means of extrusion molding or another technique.

Specific examples of the fluororesin include at least one compound selected from among polytetrafluoroethylene (PTFE), tetrafluoroethylene-hexafluoropropylene copolymer (FEP), tetrafluoroethylene-fluoroalkyl vinyl ether copolymer (PFA), ethylene-tetrafluoroethylene copolymer (ETFE), polyvinylidene fluoride (PVDF), polychlorofluoroethylene (PCTFE), and tetrafluoroethylene-hexafluoropropylene-vinylidene fluoride ternary copolymer (THV).

Tetrafluoroethylene-hexafluoropropylene copolymer (FEP), tetrafluoroethylene-fluoroalkyl vinyl ether copolymer (PFA), ethylene-tetrafluoroethylene copolymer (ETFE), and tetrafluoroethylene-hexafluoropropylene-vinylidene fluoride ternary copolymer (THV) are preferably used among the above compounds.

With thermoplastic fluororesins in particular, members of any desired shape may be extrusion-molded or otherwise formed once the fluororesin has been heated and melted.

The stretching of the fluororesin tubular member is performed after the tubular member has been extrusion-molded or otherwise formed, at a temperature that is at or below the temperature used during molding. After stretching, the member is preferably subjected to an annealing treatment at a temperature that is at or below the stretching temperature, and heat set.

The draw ratio of the fluororesin tube is preferably two to ten times as great as the length of the pre-stretched fluororesin tube.

It is not desirable for the draw ratio to be less than two times, since only a minimal effect will be achieved with regard to reducing the gas permeability; nor is it desirable for the ratio to be greater than ten, since the article will whiten, deteriorate in strength, or be otherwise adversely affected.

The stretching is preferably performed at a temperature that is at or below the molding temperature, at or above the glass transition point, and at or below the melting point.

If stretching is performed below the glass transition point, strain will increase and dimensional stability will be unobtainable. On the other hand, if stretching is performed above the melting point, rupturing will readily occur and an adequate draw ratio will be unobtainable.

The fluororesin tubular member of the present invention exhibits improved transparency after stretching, and, when used as a tube for conveying fluids, enables the state of the fluids within the tube to be confirmed in a straightforward manner. Furthermore, the stretching also improves the smoothness of the surface, which produces the effect of improving the flowability of fluids therein. The coefficient of linear expansion is reduced in the stretching direction, and both the dimensional stability and tensile strength are improved.

The present invention shall be described below with reference to inventive and comparative examples

### INVENTIVE EXAMPLE 1

A tube having an inside diameter of 13.4 mm and an outside diameter of 17.9 mm was fabricated as a result of passing tetrafluoroethylene-fluoroalkyl vinyl ether copolymer (PFA451HP-J; manufactured by Du Pont-Mitsui Fluorochemicals Co., Ltd.) from a single-screw extruder having a die temperature of 380° C. through a former.

The tube was subsequently stretched 600% at a temperature of 280° C., a travelling speed of 0.17 m/min, and a pulling speed of 1.0 m/min, whereupon an annealing treatment was performed at a temperature of 220° C., a travelling speed of 0.60 m/min, and a pulling speed of 0.50 mm/min, and a 20% shrinkage treatment was performed.

### TEST METHOD

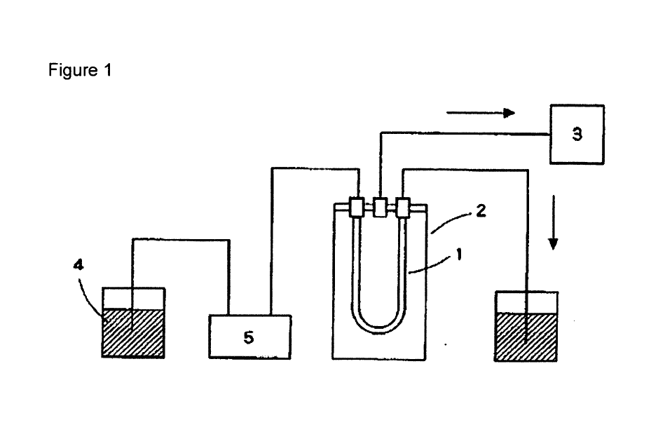

As shown in FIG. 1, the flow rate of a metering pump 5 was varied to feed oxygen-saturated purified water 4 at a temperature of 25° C. to a 1080 mm sample tube 1, which was attached to a decompression vessel 2. The oxygen concentration was 8.1 ppm. In this configuration, the decompression vessel 2 was decompressed to 5.3 kPa with a vacuum pump 3, and the amount of dissolved oxygen in the purified water that had passed through the sample tube was measured using a dissolved-oxygen-concentration measuring device. The difference between this value and the concentration of dissolved oxygen in the purified water that had not passed through the sample tube was used to determine the gas permeability of the sample tube. The results for a sample tube prepared in accordance with Inventive Example 1 are displayed in Table 1.

### COMPARATIVE EXAMPLE 1

Comparative Example 1 having an inside diameter of 6.0 mm, an outside diameter of 8.0 mm, and a wall thickness of 1.0 mm was fabricated as a result of passing tetrafluoroethylene-fluoroalkyl vinyl ether copolymer (PFA 451HP-J; manufactured by Du Pont-Mitsui Fluorochemicals Co., Ltd.) from a single-screw extruder having a die temperature of 380° C. through a former.

The sample tube used in Inventive Example 1 was replaced with Comparative Example 1 (length: 1140 mm), and the gas permeability of Comparative Example 1 was measured under the same evaluating conditions used in Inventive Example 1. The results for Comparative Example 1 are displayed in Table 1.

TABLE 1

| | | | | | | Gas |
|---|---|---|---|---|---|---|
| | Volu- | Inside | | Surface | Amount of | Perme- |
| | metric | Surface | Flow | Area of | Dissolved | ability |
| | Flow | Area | Rate | Membrane | Oxygen | g/min/ |
| | mL/min | cm² | cm/s | cm² | ppm | cm² |
| Inventive | 10 | 0.30 | 0.55 | 210.25 | 7.82 | 0.1332 |
| Example 1 | 18 | 0.30 | 0.99 | 210.25 | 7.86 | 0.2055 |
| | 30 | 0.30 | 1.66 | 210.25 | 7.91 | 0.2711 |
| Comparative | 10 | 0.28 | 0.59 | 214.78 | 7.10 | 0.4656 |
| Example 1 | 18 | 0.28 | 1.06 | 214.78 | 7.20 | 0.7543 |
| | 30 | 0.28 | 1.77 | 214.78 | 7.44 | 0.9219 |

### INVENTIVE EXAMPLE 2

A tube having an inside diameter of 12.2 mm and an outside diameter of 16.3 mm was fabricated as a result of passing tetrafluoroethylene-hexafluoropropylene copolymer (FEP NP-20; manufactured by Daikin Industries Ltd.) from a single-screw extruder having a die temperature of 380° C. through a former.

The tube was subsequently stretched 500% at a temperature of 230° C., a travelling speed of 0.20 m/min, and a pulling speed of 1.0 m/min, whereupon an annealing treatment was performed at a temperature of 180° C., a travelling speed of 0.60 m/min, and a pulling speed of 0.50 mm/min, and a 20% shrinkage treatment was performed.

The gas permeability of Inventive Example 2 (length: 1090 mm) was measured in the same manner as in Inventive Example 1. The results for Inventive Example 2 are displayed in Table 2.

### COMPARATIVE EXAMPLE 2

A tube having an inside diameter of 6.0 mm and an outside diameter of 8.0 mm was fabricated as a result of passing tetrafluoroethylene-hexafluoropropylene copolymer (FEP NP-20; manufactured by Daikin Industries Ltd.) from a single-screw extruder having a die temperature of 380° C. through a former.

The gas permeability of Comparative Example 2 (length: 1160 mm), was measured under the same evaluating conditions used in Inventive Example 1. The results for Comparative Example 2 are displayed in Table 2.

TABLE 2

| | | | | | | Gas |
|---|---|---|---|---|---|---|
| | Volu- | Inside | | Surface | Amount of | Perme- |
| | metric | Surface | Flow | Area of | Dissolved | ability |
| | Flow | Area | Rate | Membrane | Oxygen | g/min/ |
| | mL/min | cm² | cm/s | cm² | ppm | cm² |
| Inventive | 9 | 0.30 | 0.50 | 225.83 | 7.74 | 0.1435 |
| Example 2 | 13 | 0.30 | 0.72 | 225.83 | 7.80 | 0.1727 |
| | 18 | 0.30 | 0.99 | 225.83 | 7.88 | 0.1754 |
| Comparative | 9 | 0.28 | 0.53 | 205.36 | 7.44 | 0.2893 |
| Example 2 | 13 | 0.28 | 0.77 | 205.36 | 7.51 | 0.3735 |
| | 18 | 0.28 | 1.06 | 205.36 | 7.60 | 0.4383 |

### INVENTIVE EXAMPLE 3

A tube having an inside diameter of 13.4 mm and an outside diameter of 17.9 mm was fabricated as a result of passing tetrafluoroethylene-fluoroalkyl vinyl ether copolymer (950HP-plus; manufactured by Du Pont-Mitsui Fluorochemicals Co., Ltd.) from a single-screw extruder having a die temperature of 380° C. through a former.

The tube was subsequently stretched 600% at a temperature of 280° C., a travelling speed of 0.15 m/min, and a pulling speed of 0.9 m/min, whereupon an annealing treatment was performed at a temperature of 200° C., a travelling speed of 0.60 m/min, and a pulling speed of 0.50 mm/min, and a 20% shrinkage treatment was performed.

The gas permeability of Inventive Example 3 (length: 1100 mm) was measured in the same manner as in Inventive Example 1. The results for Inventive Example 3 are displayed in Table 3.

### COMPARATIVE EXAMPLE 3

A tube having an inside diameter of 6.0 mm and an outside diameter of 8.0 mm was fabricated as a result of passing tetrafluoroethylene-fluoroalkyl vinyl ether copolymer (950HP-plus; manufactured by Du Pont-Mitsui Fluorochemicals Co., Ltd.) from a single-screw extruder having a die temperature of 380° C. through a former.

The gas permeability of Comparative Example 3 (length: 1080 mm) was measured under the same evaluating conditions used in Inventive Example 1. The results for Comparative Example 3 are displayed in Table 3.

TABLE 3

| | | | | | | Gas |
|---|---|---|---|---|---|---|
| | Volu- | Inside | | Surface | Amount of | Perme- |
| | metric | Surface | Flow | Area of | Dissolved | ability |
| | Flow | Area | Rate | Membrane | Oxygen | g/min/ |
| | mL/min | cm² | cm/s | cm² | ppm | cm² |
| Inventive | 10 | 0.30 | 0.55 | 214.15 | 7.60 | 0.2335 |
| Example 3 | 17 | 0.30 | 0.94 | 214.15 | 7.74 | 0.2858 |
| | 30 | 0.30 | 1.66 | 214.15 | 7.88 | 0.3082 |
| Comparative | 10 | 0.28 | 0.59 | 203.47 | 7.03 | 0.5259 |
| Example 3 | 17 | 0.28 | 1.00 | 203.47 | 7.08 | 0.8522 |
| | 30 | 0.28 | 1.77 | 203.47 | 7.50 | 0.8846 |

1. A fluororesin tubular member, characterized in that a tubular body formed from a fluororesin is stretched in the axial direction and is heat set.

2. The fluororesin tubular member according to claim 1, wherein the fluororesin tubular member is annealed and heat set at a temperature that is at or below a molding temperature after having being stretched in a heated state at a temperature that is at or below the molding temperature.
